(19) United States
(12) Patent Application Publication
(10) Pub. No.: US 2023/0061383 A1
(43) Pub. Date: Mar. 2, 2023

(54) FASTENERS WITH INCREASED GRIP STRENGTH

(71) Applicant: PrimeSource Building Products, Inc., Irving, TX (US)

(72) Inventors: Tse-Kuang Jou, Kaohsiung (TW); Chih-Hong Lu, Kaohsiung (TW)

(21) Appl. No.: 17/462,756

(22) Filed: Aug. 31, 2021

(51) Int. Cl. F16B 15/06

(52) U.S. Cl. CPC F16B 15/06

(57) ABSTRACT

A fastener with increased grip strength is provided. Specifically, the fastener can include a head on a first end, a point on a second end opposite from the first end, and a shank in between the head and the point. A plurality of first deformations can be provided each including a first frustoconical portion and a first transition portion. One or more flutes can further be provided that extends from the point through the plurality of the first deformations forming one or more continuous helices. A plurality of second deformations can also be provided each including a second frustoconical portion and a second transition portion. The second deformations can be structurally similar to the first deformations, but having their orientations flipped 180 degrees. The fastener can also include one or more weld spaces for a collated configuration.

### FIELD OF THE INVENTION

This disclosure generally relates to a fastener with increased withdrawal resistance. More particularly, this disclosure relates to nails with improved shank designs that increase the grip strength of said nails.

### BACKGROUND OF THE INVENTION

Fasteners of different types have been widely used in many industries. Specifically, in construction and woodworking, fasteners are commonly used to join multiple pieces of objects together.

Two of the most common types of fasteners are nails and screws. Structurally, nails differ from screws in several aspects. Generally, a screw includes a drive mechanism at its screwhead that allows the screw to be driven into an object via torque from a manual or power screwdriver. Many types of screw drives are common, such as a slot screw drive or a Phillips screw drive. In contrast, a nail typically includes a flattened head on one end and can be driven into an object via a vertical force from a hammer or a nail gun. Moreover, a screw commonly includes a body, a transition, and a thread, whereas a nail commonly includes a smooth shank.

Referring to FIG. 1, a basic smooth shank nail 100 is shown. Specifically, the nail 100 can include a head 110 on a first end, a point 120 on a second end opposite from the first end, and a substantially smooth shank 130 in between the flattened head 110 and the nail point 120. To insert the nail 100 into an object, a hammer can be used to apply a vertical force upon the head 110, thereby driving the point 120 into the object. The nail 100 can be made of steel or other materials such as aluminum, brass, nickel, bronze, copper, stainless steel, wood, or plastic.

Nails and screws also have different performance characteristics. By way of example, screws typically have better grip strength and tensile strength as compared to conventional nails, whereas nails commonly have greater shear strength as compared to conventional screws.

In addition to performance characteristics, there are other reasons why a professional may choose nails over screws for a project. For example, for construction, nails are commonly used due to their ease of use and the speed of installation. Because nails can be driven into objects via a nail gun, nails can be fired in rapid successions, much faster than screws can be driven via power tools. As such, there is a constant need to improve performance characteristic of nails, and more specifically, the grip strength of nails.

One alternative design to smooth shank nails is ring shank nails. Ring shank nails include deformations in the form of annular rings or threads. Annular ring shanks increase grip strength and withdrawal resistance of the nails as opposed to smooth shanks. Ring shank nails are popularly used for drywall and deck board applications, as well as on softer woods.

Another alternative design for nails is screw shank nails. As the name suggests, screw shank nails can include deformations in the form of threads around the shank. The threads help the screw shank nails turn as they are being driven into an object—although still being driven by a hammering force instead of a rotational torque like a screw—resulting in increased driving power in hardwoods. Although screw shank nails take more force to drive than smooth shank nails or ring shank nails, the threads on the screw shank nails can provide better pull-out resistance than both smooth shank nails and ring shank nails.

Because different shank designs offer different advantages for nails as a fastener, there is a constant need to improve shank designs for better performance characteristics.

### BRIEF SUMMARY OF THE INVENTION

In view of the various shortcomings of the designs of the existing nails, several embodiments of a new and improved nail are provided herein.

According to an embodiment, a nail can include a plurality of deformations each having a frustoconical portion. The plurality of deformations can further include a transition portion. Moreover, one or more helical flutes can be provided on the nail.

According to another embodiment, a nail can include a plurality of first deformations each having a first frustoconical portion oriented to face a first end of the nail, and a plurality of second deformations each having a second frustoconical portion oriented to face a second end of the nail.

These embodiments, and other embodiments described herein, can result in nails having better grip strength and pull-out resistance as compared to conventional smooth shank nails, ring shank nails, or even conventional screw shank nails.

### BRIEF DESCRIPTION OF THE DRAWINGS

FIG. 1 illustrates a side view of a smooth shank nail;

FIG. 2A illustrates a side view of an annular ring nail according to an exemplary embodiment; FIG. 2B illustrates a side view of a deformation of the annular ring nail of FIG. 2A;

FIG. 2C illustrates a side view of an alternative deformation of the annular ring nail of FIG. 2A;

FIG. 3A illustrates a side view of an annular ring nail with flutes according to another exemplary embodiment; FIG. 3B illustrates another side view of the annular ring nail with flutes according to another exemplary embodiment;

FIG. 4 illustrates a side view of an annular ring nail with flutes according to yet another exemplary embodiment;

FIG. 5A illustrates an annular ring nail with only positive annular rings; FIG. 5B illustrates an annular ring nail with only negative annular rings; FIG. 5C illustrates an annular ring nail with both positive and negative annular rings according to an exemplary embodiment; and

FIG. 6 illustrates an annular ring nail with both positive and negative annular rings according to another exemplary embodiment.

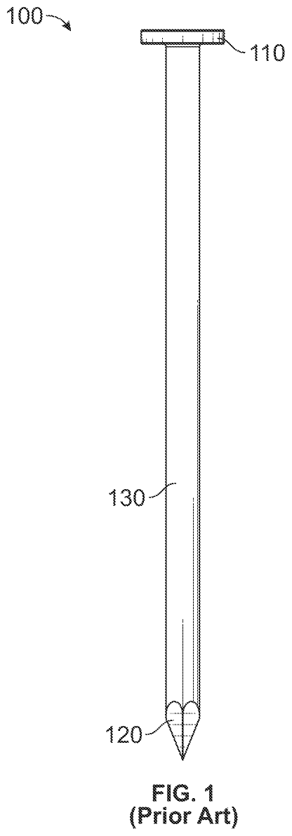

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this invention is susceptible of embodiments in many different forms, there are shown in the drawings and will be described in detail herein specific embodiments with the understanding that the present disclosure is an exemplification of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention.

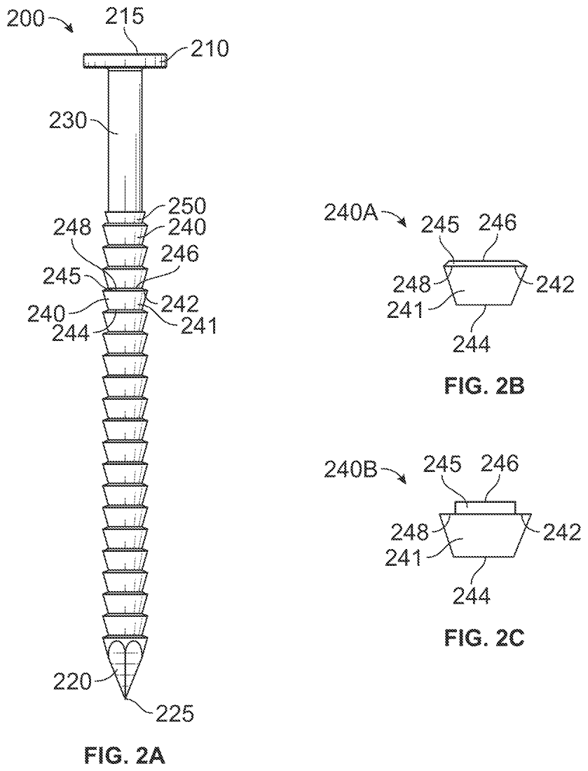

Referring to FIGS. 2A, 2B, and 2C, an annular ring nail 200 is shown. Similar to the smooth shank nail 100, the annular ring nail 200 can also include a head 210 on a first end 215, a point 220 on a second end 225 opposite from the first end 215, and a shank 230 in between the head 210 and the point 220. Further, the nail 200 can further include one or more deformations 240 in a form of annular rings or layers formed along a length of the nail 200.

The deformation 240 formed in the nail 200 is illustrated in greater details in FIG. 2B. Each of the deformations 240 can include a frustoconical portion 241 that is frustoconical in shape (or trapezoidal when viewed from a side). That is to say, the frustoconical portion 241 can include a first side 242 with a first diameter and a second side 244 with a second diameter where the first diameter is larger than the second diameter. In the exemplary embodiment as shown in FIGS. 2A and 2B, the first side 242 of the frustoconical portion 241 of each of the deformations 240 can be the side that is closer to the first end 215 of the nail 200 (i.e., the side closer to the head 210), and the second side 244 of the frustoconical portion 241 of each of the deformations 240 can be the side that is closer to the second end 225 of the nail 200 (i.e., the side closer to the point 220). Functionally, the frustoconical portion 241 of the deformations 240 can increase grip strength of the overall nail 200 as compared to having only a smooth shank. Specifically, the frustoconical portion 241 allows the nail 200 to be driven through an object, while preventing the nail 200 from being pulled out, in part due to the first side 242 of the frustoconical portion 241 being larger than the second side 244 of the frustoconical portion 241.

In some embodiments, the deformation 240 can further include a transition portion 245 to the next deformation 240 or the shank 230 as shown in more details in FIGS. 2B and 2C. As shown in FIG. 2B, the transition portion 245 portion can be proximal to the first side 242 of the frustoconical portion 241 and protrudes or extends therefrom. In an example, the transition portion 245 can also be frustoconical in shape (or trapezoidal when viewed from a side), thus, when a deformation 240A also includes a transition portion 245, the overall deformation 240A can be a combination of two frustoconical shapes combined (or hexagonal when viewed from a side). In the exemplary embodiment shown in FIG. 2B, the transition portion 245 can include a third side 246 with a third diameter and a fourth side 248 opposite from the third side 246 with a fourth diameter. The fourth side 248 of the transition portion 245 can abut the first side 242 of the frustoconical portion 241 or share a boarder therewith. The third side 246 can be the same or substantially the same diameter as the second side 244, but the third side 246 needs not be the same diameter as the second side 244. Indeed, the third side 246 can be smaller, the same or substantially the same, or larger in diameter than the first side 242 or the second side 244. Further, in the exemplary embodiment shown in FIG. 2B, the fourth side 248 is the same or substantially the same diameter as the first side 242, thus forming the frustoconical shape of the transitional portion 245. However, it is to be appreciated that the fourth side 248 need not be the same or substantially the same diameter as the first side 242.

FIG. 2C illustrates another deformation 240B that is structurally similar to the deformation 240A shown in FIG. 2B. However, in FIG. 2C, the transition portion 245 can be cylindrical in shape (or rectangular when viewed from a side), and the third side 248 can be the same or substantially the same diameter as the second side 244, which can coincide with the diameter of the shank 230. Of course, it can be appreciated that the third side 248 need not be the same diameter as the second side 244, the first side 242, or the diameter of the shank 230. In the exemplary embodiment shown in FIG. 2C, the fourth side 248 can be the same or substantially the same as the third side 246, thus forming the cylindrical shape of the transition portion 245.

Referring back to FIG. 2A, the nail 200 can also include an addition transition 250 between the deformations 240 and the shank 230. Similar to the frustoconical portion 241 of the deformations 240, the transition 250 can also be frustoconical shape (or trapezoidal when viewed from a side), and a first side 242 of the transition 250 can have a larger diameter than the second side 244 of the transition 250. In practice, the transition 250 can simply be yet another deformation 240 with similar or different dimensions as the other deformations 240 (such as half the length or size of a normal deformation 240).

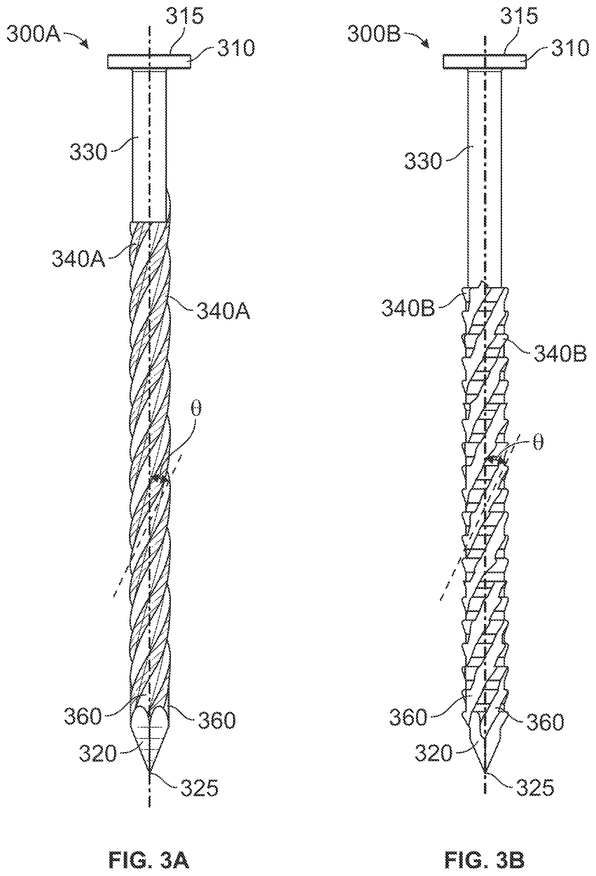

FIG. 3A illustrates an annular ring nail 300A with flutes, according to an exemplary embodiment. As before, the nail 300A can include a head 310 on a first end 315, a point 320 on a second end 325 opposite from the first end 315, and a shank 330 in between the head 310 and the point 320. Similar to nail 200, one or more deformations 340A can also be provided along the nail 300A. In the exemplary embodiment shown in FIG. 3A, each of the deformations 340A can be a double frustoconical shape (or hexagonal when viewed from a side) similar to the deformation 240A shown in FIG. 2B. Moreover, one or more helical flutes 360 can be provided on the point 320, the deformations 340A, and the shank 330. The flutes 360 can be one or more continuous helices from the point 320 up to the shank 330. Depending on the embodiments, the flutes 360 need not extend from the point 320 up to the shank 330. Instead, in certain embodiments, the flutes 360 can extend from the point 320 up through one or more deformations 340A, but does not extend all the way up to the shank 330. In some embodiments, only one flute 360 is provided on the nail 300A. In other embodiments, more than one flutes 360 can be provided on the nail 300A. Functionally, the flutes 360 can increase the ease for the nail 300A to be driven into an object by tapping its own hole similar to a cutting edge of a drill. According to some embodiments, a flute angle θ, that is the angle of the flutes 360 relative to a center axis of the nail 300A, can be about 5 to 35 degrees. In some embodiments, the flute angle θ can be between 15 to 25 degrees. In some further embodiments, the flute angle θ can be about 20 degrees.

FIG. 3B illustrates another annular ring nail 300B with flutes according to another exemplary embodiment. The nail 300B is structurally similar to the nail 300A. That is, the nail 300B can include a head 310 on a first end 315, a point 320 on a second end 325 opposite from the first end 315, and a shank 330 in between the head 310 and the point 320. Similar to nail 300A, one or more deformations 340B can also be provided on the nail 300B. The primary difference between the exemplary embodiments of FIG. 3B as opposed to FIG. 3A is that the deformations 340B of the nail 300B is similar in shape as to the deformation 240B shown in FIG. 2C. In other words, the transition portion of each of the deformations 340B is generally cylindrical in shape as opposed to being frustoconical in shape. Moreover, one or more helical flutes 360 can be provided on point 320, the deformations 340B, and the shank 330. Again, the flutes 360 can be one or more continuous helices from the point 320 up to the shank 330.

In an exemplary embodiment as shown in FIG. 3B, one individual deformation 340B can be about 1.5 millimeter (mm) to 2.5 mm in length. More specifically, the deformation 340B can be about 1.8 mm to 2.2 mm in length. Moreover, the deformation 340B can have a diameter that ranges from being about the same as a diameter of the shaft 330 to a diameter that is about 0.4 mm wider than the diameter of the shaft 330, and more particularly, the diameter of the deformations 340B can ranges from +0.1 mm to +0.3 mm of the diameter of the shaft 330. In addition, the combined length of all the deformations 340B can be between 40 percent to 90 percent of the overlength of the nail 300B. In an exemplary embodiment, the combined length of all the deformations 340B can be between 40 percent to 80 percent of the overlength of the nail 300B. According to some embodiments, a flute angle θ, that is the angle of the flutes 360 relative to a center axis of the nail 300B, can be about 5 to 35 degrees. In some embodiments, the flute angle θ can be between 15 to 25 degree. In some further embodiments, the flute angle θ can be about 20 degrees. In some embodiments, exactly four continuous flutes 360 can be provided. Based on testing, the configuration of the exemplary embodiment as shown in FIG. 3B can provide significantly increased pull-out resistance and higher grip strength as compared to conventional smooth shank nails (about 3 times), as compared to conventional ring shank nails (about 2 times), and as compared to convention screw shank nails (about 10 percent better).

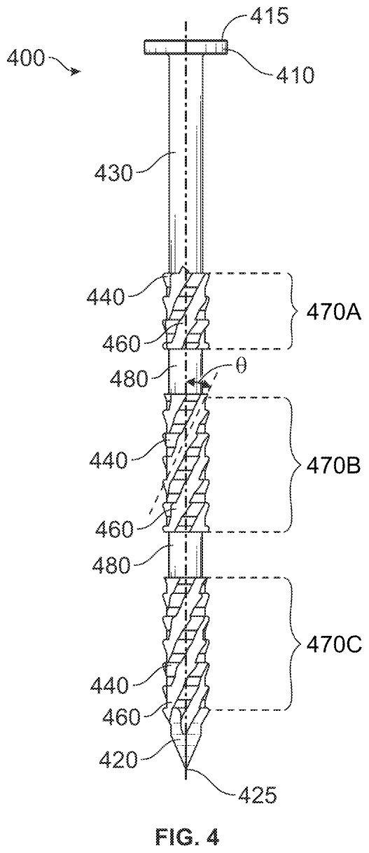

FIG. 4 illustrates an annular ring nail 400 with flutes according to yet another exemplary embodiment. The nail 400 is structurally similar to the nail 300B of FIG. 3B. That is, the nail 400 can include a head 410 on a first end 415, a point 420 on a second end 425 opposite from the first end 415, and a shank 430 in between the head 410 and the point 420. Similarly, one or more deformations 440 can also be provided on the nail 400. Moreover, one or more helical flutes 460 can be provided on point 420, the deformations 440, and the shank 430. However, unlike the nail 300B, the deformations 440 of the nail 400 can be separated into sections. In the exemplary embodiment shown in FIG. 4, the deformations 440 can be separated into three deformation sections, 470A, 470B, and 470C. Each section 470A, 470B, and 470C can have the same or different numbers of the deformation 440. By way of example, the first deformation section 470A can have four deformations 440, the second deformation section 470B can have seven deformations 440, and the third deformation section 470C can have seven deformations 440. Certainly, the number of deformations 440 within a deformation section can vary. Further, the deformation sections 470A, 470B, and 470C can also include deformations that are less than full size.

One or more weld spaces 480 can be provided in between the deformation sections 470A, 470B, 470C. The weld spaces 480 can be used for welding wires so that multiple nails 400 can be provided in a collated configuration to be used with a nail gun or other power or manual fastener drivers. Alternatively, for embodiments not provided with a weld space 480, the nails can be collated using plastic strips, paper tapes, or other appropriate means. Further, the weld spaces 480 can be substantially cylindrical in shape and shares the same or substantially the same diameter as the shaft 430. However, the weld spaces 480 need not have the same diameter as the shaft 430. Indeed, when more than one weld spaces 480 are provided, the dimensions (e.g., length and diameter) of each individual weld spaces 480 can vary from one another as well.

It is to be appreciated that although the deformations 440 are separated into deformations sections 470A, 470B, and 470C, the flutes 460 provided thereon can nonetheless still be continuous from the point 420 up to the shaft 430. That is to say, when one or more imaginary flutes are superimposed onto the weld spaces 480, the flutes 460 together with the imaginary flutes can form one or more continuous flutes from the point 420 to the shaft 430. Nevertheless, in other embodiments, the flutes 460 of one deformation section 470A, 470B, or 470C, need not correspond to the flutes 460 of another deformation section 470A, 470B, or 470C. In further embodiments, only one or more deformation sections 470A, 470B, and 470C are provided with the flutes 460, but not all the deformation sections 470A, 470B, and 470C. For example, in an embodiment, the flutes 460 can be provided on only the point 420 and the deformation section 470C, but not on the remaining deformation sections 470B and 470C. In yet another example, the flutes 460 can be provided on the point 420, the deformation section 470C, and the deformation section 470B, but not on the deformation section 470A. Certainly, the flutes 460 need not be provided on all of the deformations 440 of one of the deformation sections 470A, 470B, or 470C. For example, assuming that the deformation section 470A includes three individual deformations 440, the flutes 460 can be provided only on the bottom two deformations 440 of the deformation section 470A but not the top deformation 440. Other combinations and variations are also contemplated and are within the scope of this disclosure.

In an exemplary embodiment as shown in FIG. 4, one individual deformation 440 can be about 1.5 mm to 2.5 mm in length. More specifically, the deformation 440 can be about 1.8 mm to 2.2 mm in length. Moreover, the deformation 440 can have a diameter that ranges from being about the same as a diameter of the shaft 430 to a diameter that is about 0.4 mm wider than the diameter of the shaft 430, and more particularly, the diameter of the deformations 440 can ranges from +0.1 mm to +0.3 mm of the diameter of the shaft 430. Further, the weld spaces 480 can each be about 3 mm to 8 mm in length, and more particularly, between 4 mm and 7 mm. In addition, the combined length of all the deformations 440 can be between 40 percent to 90 percent of the overlength of the nail 400. In an exemplary embodiment, the combined length of all the deformations 440 can be between 40 percent to 80 percent of the overlength of the nail 400. According to some embodiments, a flute angle θ, that is the angle of the flutes 460 relative to a center axis of the nail 400, can be about 5 to 35 degrees. In some embodiments, the flute angle θ can be between 15 to 25 degree. In some further embodiments, the flute angle θ can be about 20 degrees. In some embodiments, exactly four flutes 460 can be provided on each of the deformation sections 470A, 470B, and 470C, where the flutes 460 of these sections together form four continuous flutes 460 when imaginary helical lines are extended from the flutes 460 positioned within one deformation section to the flutes 460 positioned in the next deformation section.

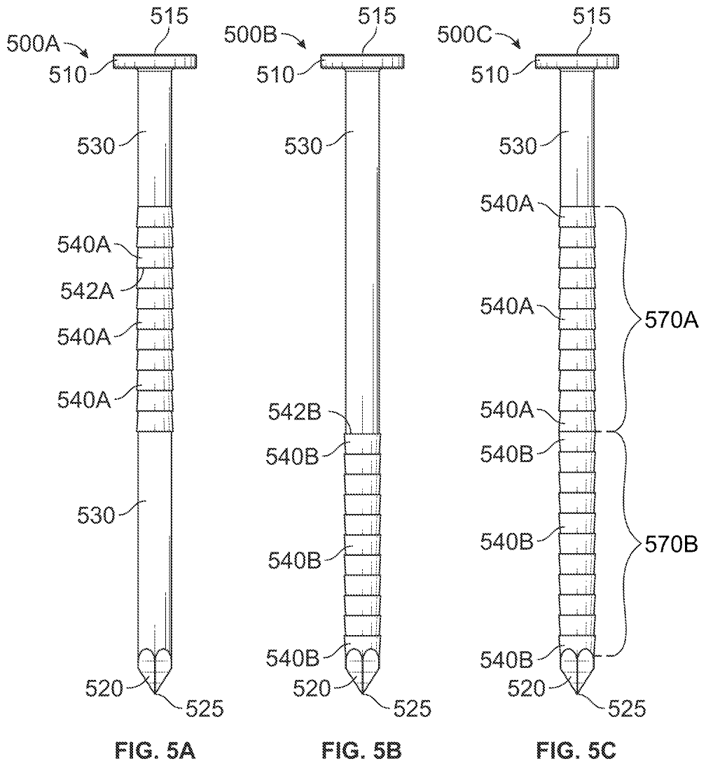

FIGS. 5A, 5B, and 5C illustrate three annular ring nails 500 according to additional exemplary embodiments. As before, the nail 500 can also include a head 510 on a first end 515, a point 520 on a second end 525 opposite from the first end 515, and a shank 530 in between the head 510 and the point 520. Likewise, one or more 540 in a form of annular rings or layers can be provided on the nail 500.

Referring to FIG. 5A, a deformation 540A can include a frustoconical portion that is frustoconical in shape (or trapezoidal when viewed from a side). However, unlike the frustoconical portion 241 of the deformation 240A shown in FIG. 2B, the frustoconical portion of the deformation 540A can have its wider diameter side 542A facing toward the point 520 (i.e., the second end 525 of the nail 500A). Given the reverse direction of the frustoconical portion of the deformation 540A as compared to other deformations illustrated such as the deformation 240A of FIG. 2B or the deformation 540B of the FIG. 5B, the deformation 540A with its wider side 542A facing toward the second end 525 of the nail 500A can be known as a “positive” deformation or a “positive” ring or layer.

Referring to FIG. 5B, a frustoconical portion of a deformation 540B can have its wider side 542B facing the head 510 (i.e., the first end 515 of the nail 500B) similar to the deformation 240A of FIG. 2B, as such, the deformation 540B with its wider side 542B facing toward the first end 515 of the nail 500B can be known as a “negative” deformation or a “negative ring or layer.

Referring to FIG. 5C, the nail 500C can include both positive deformations 540A and negative deformations 540B. In the exemplary embodiment shown in FIG. 5C, the positive deformations 540A are grouped into a first deformation section 570A, and the negative deformations 540B are grouped into a second deformation section 570B. In this specific exemplary embodiment shown in FIG. 5C, the first deformation section 570A can be proximal to the head 510 (i.e., closer to the first end 515 of the nail 500C), and the second deformation section 570B can be proximal to the point 520 (i.e., closer to the second end 525 of the nail 500C). Alternatively, the positive deformations 540A can be provided proximal to the point 520, and the negative deformations 540B can be provided proximal to the head 510. Of course, any number of deformation sections 570 can be provided on a nail 500C. Likewise, the positive/negative deformations 540A and 540B do not have to be grouped together with other positive/negative deformations 540A and 540B. Indeed, it is contemplated that the positive deformations 540A can intermix with the negative deformations 540B within a given deformation section. Moreover, one of more flutes can be provided on the point 520, the positive deformations 540A and/or the negative deformations 540B, and/or the shaft 530.

In an exemplary embodiment, one individual positive deformation 540A or negative deformation 540B can be about 1.5 mm to 2.5 mm in length. More specifically, the positive deformation 540A or the negative deformation 540B can each be about 1.8 mm to 2.2 mm in length. Moreover, the positive deformations 540A or the negative deformations 540B can each have a diameter that ranges from being about the same as a diameter of the shaft 530 to a diameter that is about 0.4 mm wider than the diameter of the shaft 530, and more particularly, the diameter of the positive deformations 540A or the negative deformations 540B can ranges from +0.1 mm to +0.3 mm of the diameter of the shaft 530. Further, according to an exemplary embodiment, the first deformation section 570A and the second deformation section 570B can each be about 15 mm to 35 mm in length. More specifically, the first deformation section 570A and the second deformation section 570B can each be about 20 mm to 30 mm in length. In addition, the combined length of the first deformation section 570A and the second deformation section 570B can be between 40 percent to 90 percent of the overlength of the nail 500C. In an exemplary embodiment, the combined length of the first deformation section 570A and the second deformation section 570B can be between 50 percent to 80 percent of the overlength of the nail 500C.

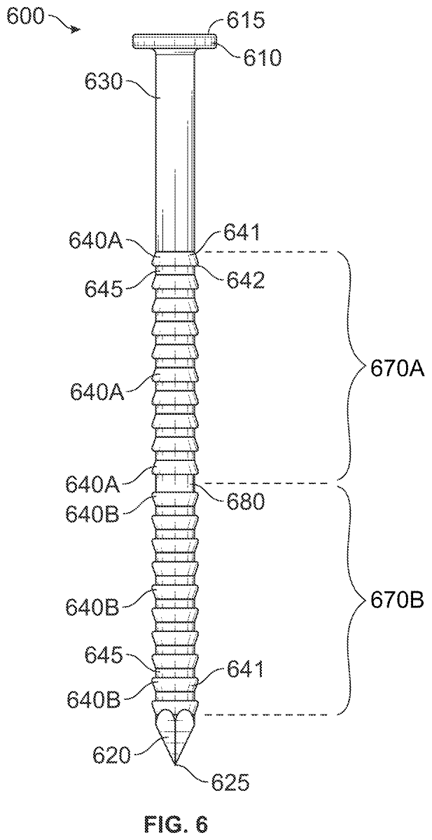

FIG. 6 illustrates an annular ring nail 600 according to another exemplary embodiment. Similar to nail 500C of FIG. 5C, the nail 600 can also include a head 610 on a first end 615, a point 620 on a second end 625 opposite from the first end 615, and a shank 630 in between the head 610 and the point 620. Likewise, one or more deformations 640A and 640B in a form of annular rings or layers can be provided on the nail 600. The primary difference between the nail 600 of FIG. 6 and the nail 500C of FIG. 5C is the deformations. Specifically, although the nail 600 can also be provided with positive deformations 640A and negative deformations 640B, the positive deformations 640A and the negative deformations 640B can each further include a transition portion 645 similar to the transition portion 245 shown in FIG. 2C. In the exemplary embodiment shown in FIG. 6, the transition portions 645 can each be cylindrical in shape (or rectangular when viewed from a side). However, the transition portions 645 of the positive deformations 640A or the negative deformations 640B can also be other shapes, such as frustoconical (or trapezoidal when viewed from a side) similar to the transition portion 240A shown in FIG. 2B. Moreover, the transition portion 645 can extend from the wider side 642 of a frustoconical portion 641 of the deformations 640A or 640B similar to the deformation 240B shown in FIG. 2C. When the transition portions 645 are cylindrical in shape, the transition portions can have the same or substantially the same diameter as the shaft 630. However, the diameter of the transition portions 645 needs not coincide with the diameter of the shaft 630.

In the exemplary embodiment shown in FIG. 6, the positive deformations 640A can be grouped into a first deformation section 640A, and the negative deformations 640B can be grouped into a second deformation section 670B. In this specific exemplary embodiment shown in FIG. 6, the first deformation section 670A can be proximal to the head 610 (i.e., closer to the first end 615 of the nail 600), and the second deformation section 670B can be proximal to the point 620 (i.e., closer to the second end 625 of the nail 600). Alternatively, the positive deformations 640A can be provided proximal to the point 620, and the negative deformations 640B can be provided proximal to the head 610. Of course, any number of deformation sections 670 can be provided on a nail 600. Likewise, the positive/negative deformations 640A and 640B do not have to be grouped together with other positive/negative deformations 640A and 640B. Indeed, it is contemplated that the positive deformations 640A can intermix with the negative deformations 640B within a given deformation section. Moreover, one of more flutes can be provided on the point 620, the positive deformations 640A and/or the negative deformations 640B, and/or the shaft 630.

Referring to the specific exemplary embodiment shown in FIG. 6, at the intersection of the positive deformations 640A and the negative deformations 640B, the transition portion 645 of the respective positive deformation 640A and negative deformation 640B can be combined to form a weld space 680 that can be used for welding wires so that multiple nails 600 can be provided in a collated configuration to be used with a nail gun or other mechanical or manual fastener drivers. Otherwise, the nails 600 can be collated using plastic strips, paper tapes, or other appropriate means.

In an exemplary embodiment, one individual positive deformation 640A or negative deformation 640B (including both the frustoconical portion 641 and the transition portion 645) can be about 1.5 mm to 2.5 mm in length. More specifically, the positive deformation 640A or the negative deformation 640B can each be about 1.8 mm to 2.2 mm in length. Moreover, the positive deformations 640A or the negative deformations 640B can each have a diameter that ranges from being about the same as a diameter of the shaft 630 to a diameter that is about 0.4 mm wider than the diameter of the shaft 630, and more particularly, the diameter of the positive deformations 640A or the negative deformations 640B can ranges from +0.1 mm to +0.3 mm of the diameter of the shaft 630. Further, according to an exemplary embodiment, the first deformation section 670A and the second deformation section 670B can each be about 15 mm to 35 mm in length. More specifically, the first deformation section 670A and the second deformation section 670B can each be about 20 mm to 30 mm in length. In addition, the combined length of the first deformation section 670A and the second deformation section 670B can be between 40 percent to 90 percent of the overlength of the nail 600. In an exemplary embodiment, the combined length of the first deformation section 670A and the second deformation section 670B can be between 50 percent to 80 percent of the overlength of the nail 600. Based on testing, the configuration of the exemplary embodiment as shown in FIG. 6 can provide increased pull-out resistance and higher grip strength as compared to conventional smooth shank nails, as compared to conventional ring shank nails (about 2 times), and as compared to convention screw shank nails (about 30 percent better).

Specific embodiments of a fastener according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Specifically, although various embodiments describe a nail as an example, it is to be understood that the same principals can be applied to other types of fasteners. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A fastener comprising:
a head on a first end of the fastener;
a point on a second end of the fastener opposite from the first end;
a shank in between the head and the point;
a plurality of deformations positioned between the head and the point, the plurality of deformations each including a frustoconical portion; and
a flute that forms a helix along the plurality of the deformations.

2. The fastener of claim 1, wherein the frustoconical portion of the plurality of the deformations includes a first side with a first diameter and a second side opposite from the first side with a second diameter, and the first diameter being larger than the second diameter.

3. The fastener of claim 2, wherein the frustoconical portion of the plurality of the deformations is oriented such that the first side is closer to the first end of the fastener and the second side is closer to the second end of the fastener.

4. The fastener of claim 3, wherein the plurality of the deformations each further comprising a transition portion extending from the first side of the frustoconical portion toward the first end of the fastener;
the transition portion having a third side with a third diameter and a fourth side opposite from the third side with a fourth diameter, wherein the fourth side of the transition portion abuts the first side of the frustoconical portion.

5. The fastener of claim 4, wherein the transition portion is frustoconical in shape, and the third diameter is smaller than the fourth diameter.

6. The fastener of claim 5, wherein the fourth diameter is the same or substantially the same as the first diameter of the frustoconical portion.

7. The fastener of claim 4, wherein the transition portion is cylindrical in shape, and the third diameter is the same or substantially the same as the fourth diameter.

8. The fastener of claim 1, wherein the flute forms a continuous helix that extends from the point through the plurality of the deformations.

9. The fastener of claim 1, wherein the flute has a flute angle of about 15 to 25 degrees.

10. The fastener of claim 1 further comprising a weld space that divides the plurality of the deformations into at least two deformation sections.

11. The fastener of claim 10, wherein the flute forms a continuous helix that extends from the point through the plurality of the deformations when an imaginary helix line is extended from one deformation section to another deformation section through the weld space.

12. The fastener of claim 1, wherein the fastener is a nail.

13. A fastener comprising:
a head on a first end of the fastener;
a point on a second end opposite from the first end of the fastener;
a shank in between the head and the point;
a plurality of first deformations positioned between the head and the point, the plurality of first deformations each including a first frustoconical portion; and
a plurality of second deformations positioned between the head and the point, the plurality of second deformations each including a second frustoconical portion.

14. The fastener of claim 13, wherein the plurality of second deformations is positioned closer to the first end of the fastener, and the plurality of the first deformations is positioned closer to the second end of the fastener.

15. The fastener of claim 14, wherein the first frustoconical portion of the plurality of the first deformations includes a first side with a first diameter and a second side opposite from the first side with a second diameter, and the first diameter is larger than the second diameter; and
wherein the second frustoconical portion of the plurality of the second deformations includes a third side with a third diameter and a fourth side opposite from the third side with a fourth diameter, and the fourth diameter is larger than the third diameter.

16. The fastener of claim 15, wherein the first frustoconical portion of the plurality of the first deformations is oriented such that the first side is closer to the first end of the fastener and the second side is closer to the second end of the fastener; and
the second frustoconical portion of the plurality of the second deformations is oriented such that the third side is closer to the first end of the fastener and the fourth side is closer to the second end of the fastener.

17. The fastener of claim 16, wherein the plurality of the first deformations each further comprising a first transition portion extending from the first side of the frustoconical portion toward the first end of the fastener, the first transition portion having a fifth side with a fifth diameter and a sixth side opposite from the fifth side with a sixth diameter, wherein the sixth side of the transition portion abuts the first side of the first frustoconical portion; and
the plurality of the second deformations each further comprising a second transition portion extending from the fourth side of the second frustoconical portion toward the second end of the fastener, the second transition portion having a seventh side with a seventh diameter and an eighth side opposite from the seventh side with an eighth diameter, wherein the seventh side of the second transition portion abuts the fourth side of the second frustoconical portion.

18. The fastener of claim 17, wherein the first transition portion and the second transition portion are both frustoconical in shape, the fifth diameter is smaller than the sixth diameter, and the eighth diameter is smaller than the seventh diameter.

19. The fastener of claim 17, wherein the first transition portion and the second transition portion are both cylindrical in shape, the fifth diameter is the same or substantially the same as the sixth diameter, and the eighth diameter is the same or substantially the same as the seventh diameter.

20. The fastener of claim 13, wherein the fastener is a nail.
